(19) United States
(12) Patent Application Publication
(10) Pub. No.: US 2014/0173490 A1
(43) Pub. Date: Jun. 19, 2014

(54) SELECTION OF FILES FOR ALBUM CREATION ON ELECTRONIC DEVICES

(71) Applicant: RESEARCH IN MOTION LIMITED, Waterloo (CA)

(72) Inventors: Daryl Joseph MARTIN, Kitchener (CA); Conor Michael O'NEILL, Waterloo (CA); Marcin CIETWIERKOWSKI, Kitchener (CA)

(73) Assignee: RESEARCH IN MOTION LIMITED, Waterloo (CA)

(21) Appl. No.: 13/718,375

(22) Filed: Dec. 18, 2012

(51) Int. Cl. G06F 3/0484

(52) U.S. Cl. CPC G06F 3/04847
USPC 715/772

(57) ABSTRACT

A method of selecting a group of files on an electronic device. The method includes rendering a slide bar on a display of the electronic device, the slide bar configured to display a time period corresponding to a temporal characteristic of one or more of multiple files stored in memory of the electronic device, responsive to user manipulation of the slide bar adjusting the time period represented by the slide bar, and responsive to user input creating an album and placing the files having temporal characteristic within the adjusted time period in the album.

### FIELD OF THE INVENTION

The present invention relates generally to electronic devices and more specifically to the selection of files for albums on such devices.

### BACKGROUND

Modern electronic devices such as cell phones, smart phones, and digital cameras may be used to capture photographic still images and video segments. These mobile electronic devices often have a fixed or removable electronic memory component that has a relatively large storage capacity. Such large capacity memory components provide a user with the ability to store on the devices large numbers of files such as digital photographs and video files. In particular, it is now possible for a user to store several thousand separate digital photographs on a single memory chip prior to their deletion or transfer to a more permanent storage device. In general, each image is assigned a sequentially ordered file name by the mobile device as that image is captured.

Users accordingly tend to have hundreds of pictures and videos stored in their default camera memory location. Moreover, cellular telephones and smart phones with their larger memories can also have numerous pictures and videos stored in memory. Organizing such large numbers of pictures and videos can be very time consuming and tedious as the items are often selected and manually moved into directories one at a time or in small groups.

### BRIEF DESCRIPTION OF THE DRAWINGS

The accompanying drawings provide visual representations which will be used to more fully describe various representative embodiments and can be used by those skilled in the art to better understand the representative embodiments disclosed herein and their inherent advantages. In these drawings, like reference numerals identify corresponding elements.

FIG. 1 is a drawing of a block diagram of an electronic device configured for album creation of date related files as described in various representative embodiments.

FIG. 2 is another drawing of the mobile electronic device of FIG. 1.

FIG. 3 is a drawing of the slide bar of the mobile electronic device of FIG. 1.

FIG. 4 is a flow chart of a method for selecting a group of captured date related files on a mobile electronic device as described in various representative embodiments.

FIG. 5 is a flow chart of another method for selecting a group of captured date related files on a mobile electronic device as described in various representative embodiments.

### DETAILED DESCRIPTION

As shown in the drawings for purposes of illustration and as described below, novel techniques are disclosed for selecting files such as photographic or video files for subsequent placement in created albums on an electronic device which could be a mobile electronic device. Users tend to have hundreds of pictures and videos stored in their default camera memory location. Cellular telephones and smart phones now with their larger memories can also have numerous pictures and videos stored in their memories. Organizing such large numbers of pictures and videos can be very time consuming and tedious as the items are often selected and manually moved into directories one at a time or in small groups. Thus, there is a need for a better way to select files which could be photographic items such as pictures and videos for subsequent placement in created albums on mobile electronic devices.

It can be assumed that photographs and videos taken over given time periods are related to specific events. For example, a trip to Europe would include pictures taken over the span of the trip, perhaps a week or so. Whereas, a party might cover the span of an evening. As disclosed herein, a user is provided access to a slider bar at the bottom or other location of a display of a mobile electronic device. The slider bar designates a time period which can be expanded and contracted by the user. The time period displayed designates a range of times within which a group of files stored in the mobile device memory were captured. As the user adjusts the displayed time period, the group of files associated via their capture times adjusts accordingly. Once the user has adjusted the time period to his/her satisfaction, he/she is prompted to assign an album name. Subsequently, the associated files will be copied or moved into the album.

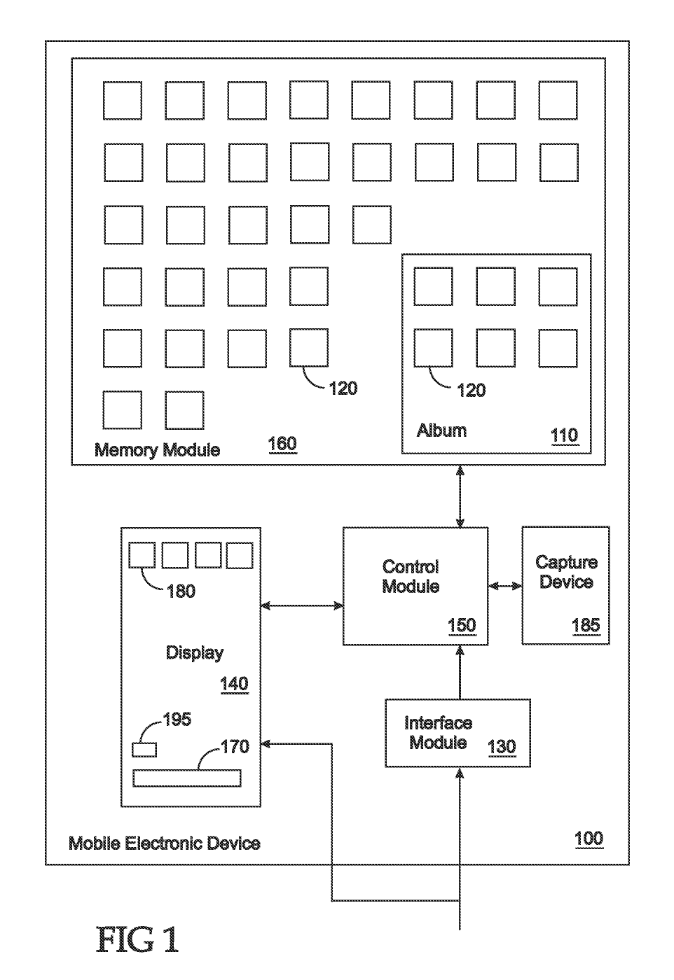

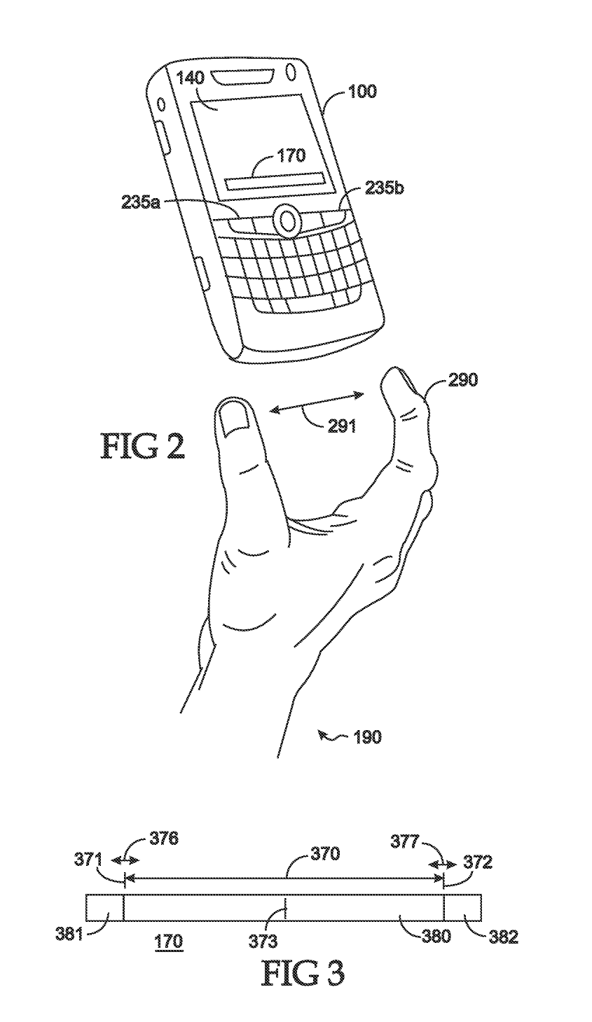

FIG. 1 is a drawing of a block diagram of an electronic device 100 configured for album 110 creation of date related files 120 as described in various representative embodiments. The electronic device 100 could be a mobile electronic device 100 and will be referred to in the following as such. However, the electronic device 100 is not limited to mobile electronic devices 100. The mobile electronic device 100 could be a cellular telephone 100, a smart phone 100, a digital camera 100, or other appropriate mobile electronic device 100. The date related files 120 could be photographic items 120 such as photographs 120 and videos 120 or other appropriate files 120. The mobile electronic device 100 comprises an interface module 130, a display 140 which in representative embodiments could be a touchscreen 140, a control module 150 which is also referred to herein as a processor 150, and a memory module 160. The interface module 130 is accessible to a user 190 (see FIG. 2). In alternative embodiments, the display 140 is also accessible to the user 190. The interface module 130, the display 140, and the memory module 160 are coupled to the control module 150.

The memory module 160 is configured for storing multiple files 120 in captured sequence. The files 120 could be photographs or videos. The display 140 is configured for presentation of a slide bar 170, for optional presentation of representations 180 of one or more date related files 120 stored in the memory module 160, and for optional presentation of an item counter 195 which indicates the number of files 120 that have a temporal characteristic lying within the time period 370 (see FIG. 3) indicated by the slide bar 170. The temporal characteristic of each of the files 120 could be the capture time, the storage time, the modification time of the file 120, or other appropriate file 120 temporal characteristic. In the following, the temporal characteristic of a file 120 will be referred to as the capture time but is not limited to such. For ease and clarity of illustration only one of the optional representations 180 shown in FIG. 1 is identified via its identifying number. The user 190 can provide instructions to the mobile electronic device 100 via the slide bar 170 on the display 140 or via the interface module 130. User 190 instructions provided via the slide bar 170 on the display 140 and the interface module 130 are transferred to the control module 150. The control module 150 communicates with the memory module 160. As will be discussed more fully with the description of FIG. 2, the instructions from the user 190 via the slide bar 170 can result in the creation of one or more albums 110 and the subsequent placement of one or more files 120 in the created albums 110. For ease and clarity of illustration only one of the files 120 shown stored in the memory module 160 is identified via its identifying number in FIG. 1, and only one of the files 120 shown stored in the album 110 is identified via its identifying number in FIG. 1. The memory module 160 could comprise multiple albums 110. The mobile electronic device 100 can also comprise a capture device 185 configured for capturing the files 120 which are then stored by capture date and time in the memory module 160. The capture device 185 is coupled to the control module 150 in the representative embodiment of FIG. 1.

FIG. 2 is another drawing of the mobile electronic device 100 of FIG. 1. The slide bar 170 displayed on the display 140 of the mobile electronic device 100 represents a time period which can be adjusted via movement 291 of the fingers 290 of the user 190 on or in proximity to the slide bar 170 or alternatively the time period can be adjusted via activation of adjustment keys 235a, 235b on the interface module 130. The time period delineated on the slide bar 170 corresponds to the capture time of one or more of the files 120. By adjusting the time period displayed on the slide bar 170, a group of files 120 stored on the mobile electronic device 100 can be selected. In response to instructions from the user 190 an album 110 can be created for those files 120 having capture times delineated by the time period displayed on the slide bar 170 and those files 120 can be subsequently placed in the album 110.

FIG. 3 is a drawing of the slide bar 170 of the mobile electronic device 100 of FIG. 1. The slide bar 170 presents time bar 380 having a start time 371 and an end time 372 that delineate a time period 370. The start time 371 and end time 372 are separately adjustable 376, 377 by the user 190. The slide bar 170 can also comprise a preceding segment bar 381 representing a time segment preceding that of the time period 370 and a succeeding segment bar 382 representing a time segment succeeding that of the time period 370. In a representative embodiment, one of the files 120 could be selected which then identifies a first time 373. The slide bar 170 could then be expanded about this first time 373 at the user's 190 discretion to include additional files 120.

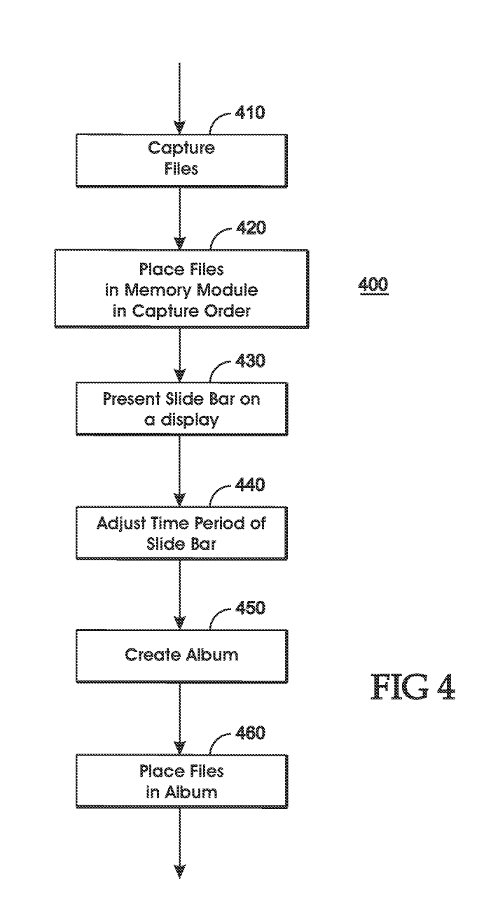

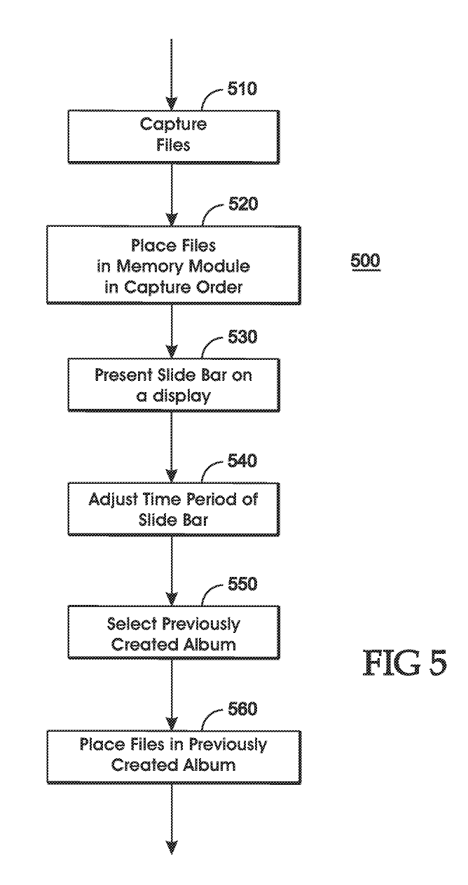

FIG. 4 is a flow chart of a method 400 for selecting a group of captured date related files 120 on a mobile electronic device 100 as described in various representative embodiments. The mobile electronic device 100 could be a cellular telephone 100, a smart phone 100, a digital camera 100, or other appropriate mobile electronic device 100. The date related files 120 could be photographic items 120 such as photographs 120 and videos 120 or other appropriate files 120. In block 410 of FIG. 4, various files 120 are captured by a capture device 185 on the mobile electronic device 100. Block 410 then transfers control to block 420.

In block 420, the files 120 are stored in a memory module 160 on the mobile electronic device 100 in captured sequence. Block 420 then transfers control to block 430.

In block 430, a slide bar 170 is presented on a display 140 which could be a touchscreen 140 of the mobile electronic device 100. The slide bar 170 displays a time period 370 corresponding to the capture time of one or more of the multiple files 120. Block 430 then transfers control to block 440.

In block 440, responsive to movement 291 of a user's 190 fingers 290 on or in proximity to the slide bar 170 or alternatively responsive to activation of adjustment keys 235a, 235b, the time period 370 represented by the slide bar 170 is adjusted. In a representative embodiment, one of the files 120 could be selected which then identifies a first time 373. The slide bar 170 could then be expanded about this first time 373 at the user's 190 discretion to include additional files 120. In another representative embodiment, the user 190 could adjust whatever time period 370 the control module 150 presented on the display 140. Block 440 then transfers control to block 450.

In block 450, responsive to user 190 instructions, an album 110 is created in the memory module 160 on the mobile electronic device 100. Block 450 then transfers control to block 460.

In block 460, responsive to user 190 instructions, all files 120 captured within the adjusted time period 370 are placed in the album 110. Block 460 then terminates the process.

FIG. 5 is a flow chart of a method 500 for selecting a group of captured date related files 120 on a mobile electronic device 100 as described in various representative embodiments. The mobile electronic device 100 could be a cellular telephone 100, a smart phone 100, a digital camera 100, or other appropriate mobile electronic device 100. The date related files 120 could be photographic items 120 such as photographs 120 and videos 120 or other appropriate files 120. In block 510 of FIG. 5, various files 120 are captured by a capture device 185 on the mobile electronic device 100. Block 510 then transfers control to block 520.

In block 520, the files 120 are stored in a memory module 160 on the mobile electronic device 100 in captured sequence. Block 520 then transfers control to block 530.

In block 530, a slide bar 170 is presented on a display 140 which could be a touchscreen 140 of the mobile electronic device 100. The slide bar 170 displays a time period 370 corresponding to the capture time of one or more of the multiple files 120. Block 530 then transfers control to block 540.

In block 540, responsive to movement 291 of a user's 190 fingers 290 on or in proximity to the slide bar 170 or alternatively responsive to activation of adjustment keys 235a, 235b, the time period 370 represented by the slide bar 170 is adjusted. In a representative embodiment, one of the files 120 could be selected which then identifies a first time 373. The slide bar 170 could then be expanded about this first time 373 at the user's 190 discretion to include additional files 120. In another representative embodiment, the user 190 could adjust whatever time period 370 the control module 150 presented on the display 140. Block 540 then transfers control to block 550.

In block 550, responsive to user 190 instructions, select a previously created album 110 in the memory module 160 on the mobile electronic device 100. Block 550 then transfers control to block 560.

In block 560, responsive to user 190 instructions, all files 120 captured within the adjusted time period 370 except any that were previously placed in the previously created album 110 are placed in the previously created album 110. Block 560 then terminates the process.

The memory module 160 is configured for storing multiple files 120 in captured sequence. The files 120 could be photographs or videos. The touchscreen 140 is configured for presenting the slide bar 170.

In another representative embodiment, a non-transitory computer-readable medium 160 is disclosed. The non-transitory computer-readable medium has computer-executable instructions for causing a computer which includes a processor 150 and associated memory 160 to carry out a method 400 for selecting a group of captured files 120 on a mobile electronic device 100. The method 400 includes presenting a slide bar 170 on a display 140, responsive to user 190 input adjusting the time period 370 represented by the slide bar 170, and responsive to user 190 instructions, creating an album 110 and placing all files 120 captured within the adjusted time period in the album 110. The multiple files 120 are stored in a memory module 160 in captured sequence; the display 140 and the memory module 160 are components of the mobile electronic device 100; and the slide bar 170 displays a time period 370 corresponding to the capture time of one or more of the multiple files 120.

As previously stated, while the electronic device 100 is referred to in the above as a mobile electronic device 100, the electronic device 100 is not limited to mobile electronic devices 100. It could be a computer 100 or other appropriate electronic device 100. Also as previously stated, while the temporal characteristic of each of the files 120 is referred to above as the capture time, it could also be the storage time of the file 120, the modification time of the file 120, or other appropriate file 120 temporal characteristic.

In light of the above, it can be seen that in accordance with aspects of the disclosure an electronic device 100 includes a memory 160 configured for storing multiple files 120 based on a temporal characteristic of each file 120 and a processor 150 configured to render a slide bar 170 on a display 140, the slide bar 170 representing a time period 370 adjustable by a user 190 that corresponds to the temporal characteristic of one or more of the multiple files 120, the processor 150 further configured to create an album 110 responsive to a user directive and to place the files 120 having temporal characteristic within the adjusted time period 370 in the album 110.

In accordance with various aspects of the disclosure a method 400 for selecting a group of captured files 120 on an electronic device 100 is provided. The method 400 includes rendering a slide bar 170 on a display 140 of the electronic device 100, the slide bar 170 configured to display a time period 370 corresponding to a temporal characteristic of one or more of multiple files 120 stored in memory 160 of the electronic device 100 in sequence, responsive to user manipulation of the slide bar 170, adjusting the time period 370 displayed, and responsive to user input, creating an album 110 and placing the files 120 having temporal characteristic within the adjusted time period 370 in the album 110.

In accordance with various aspects of the disclosure, a non-transitory computer-readable medium 160 is further provided. The non-transitory computer-readable medium 160 has computer-executable instructions for causing a computer which includes a processor 150 and associated memory 100 to carry out a method 400 on an electronic device 100. The method 400 comprises rendering a slide bar 170 on a display 140 of the electronic device 100, the slide bar 170 configured to display a time period 370 corresponding to a temporal characteristic of one or more of multiple files 120 stored in memory 100 of the electronic device 100 in sequence, responsive to user manipulation of the slide bar 170, adjusting the time period 370 displayed, and responsive to user input, creating an album 110 and placing the files 120 having temporal characteristic within the adjusted time period 370 in the album 110.

The representative embodiments, which have been described in detail herein, have been presented by way of example and not by way of limitation. It will be understood by those skilled in the art that various changes may be made in the form and details of the described embodiments resulting in equivalent embodiments that remain within the scope of the appended claims.

What is claimed is:

1. An electronic device, comprising:
memory configured for storing multiple files based on a temporal characteristic of each file; and
a processor configured to render a slide bar on a display, the slide bar representing an adjustable time period that corresponds to the temporal characteristic of one or more of the multiple files, the processor further configured to create an album responsive to a user directive and to place the files within the adjusted time period in the album in accordance with the temporal characteristic of each file.

2. The electronic device of claim 1, wherein the time period displayed is adjustable via manual activation of adjustment keys on the electronic device.

3. The electronic device of claim 1, wherein the display is a touchscreen and wherein the time period displayed is adjustable via movement of the user's fingers on or in proximity to the slide bar on the touchscreen.

4. The electronic device of claim 1, wherein the temporal characteristic comprises the file's capture time, storage time, or modification time.

5. The electronic device of claim 1 wherein the electronic device is one or more of a cellular telephone, a smart phone, and a digital camera.

6. The electronic device of claim 1 wherein the processor is further configured to render a representation of one or more of the multiple files having temporal characteristics within the time period and/or to render an item counter configured for displaying the number of files having temporal characteristics within the time period.

7. The electronic device of claim 1 wherein the multiple files are photographic items comprising one or more digital photographs and/or digital videos.

8. The electronic device of claim 1, wherein the multiple files are stored in captured sequence in accordance with the temporal characteristic of each file.

9. A method for selecting a group of files on an electronic device, comprising:
rendering a slide bar on a display of the electronic device, the slide bar configured to display a time period corresponding to a temporal characteristic of one or more of multiple files stored in memory of the electronic device;
responsive to user manipulation of the slide bar, adjusting the time period displayed; and
responsive to user input, creating an album and placing the files having temporal characteristic within the adjusted time period in the album.

10. The method of claim 9, wherein the time period displayed is adjusted via manual activation of adjustment keys on the electronic device.

11. The method of claim 9, wherein the display is a touchscreen and wherein the time period displayed is adjusted via movement of the user's fingers on or in proximity to the slide bar on the touchscreen.

12. The method of claim 9, wherein the temporal characteristic comprises the file's capture time, storage time, or modification time.

13. The method of claim 9, wherein the electronic device is one or more of a cellular telephone, a smart phone, and a digital camera.

14. The method of claim 9, further comprising:
rendering on the touchscreen a representation of one or more of the multiple files having temporal characteristics in the time period.

15. The method of claim 9, wherein the multiple files are photographic items comprising one or more digital photographs and/or digital videos.

16. The method of claim 9, wherein the one or more of multiple files are stored in captured sequence in memory of the electronic device in accordance with the temporal characteristic of each of the one or more of multiple files.

17. A non-transitory computer-readable medium having computer-executable instructions for causing a computer comprising a processor and associated memory to carry out a method on an electronic device, the method comprising:
rendering a slide bar on a display of the electronic device, the slide bar configured to display a time period corresponding to a temporal characteristic of one or more of multiple files stored in memory of the electronic device;
responsive to user manipulation of the slide bar, adjusting the time period displayed; and
responsive to user input, creating an album and placing the files having temporal characteristic within the adjusted time period in the album.

18. The non-transitory computer-readable medium of claim 17, wherein the time period displayed is adjusted via manual activation of adjustment keys on the electronic device.

19. The non-transitory computer-readable medium of claim 17, wherein the display is a touchscreen and wherein the time period displayed is adjusted via movement of the user's fingers on or in proximity to the slide bar on the touchscreen.

20. The non-transitory computer-readable medium of claim 17, wherein the temporal characteristic comprises the file's capture time, storage time, or modification time.

21. The non-transitory computer-readable medium of claim 17, wherein the electronic device is one or more of a cellular telephone, a smart phone, and a digital camera.

22. The non-transitory computer-readable medium of claim 17, wherein the multiple files are photographic items comprising one or more digital photographs and/or digital videos.
